(19) United States
(12) Patent Application Publication
(10) Pub. No.: US 2005/0222901 A1
(43) Pub. Date: Oct. 6, 2005

(54) Determining ad targeting information and/or ad creative information using past search queries

(76) Inventors: Sumit Agarwal, San Carlos, CA (US); Pearl Renaker, San Francisco, CA (US); Adam Smith, Mountain View, CA (US)

Correspondence Address: STRAUB & POKOTYLO, 620 TINTON AVENUE, BLDG. B, 2ND FLOOR, TINTON FALLS, NJ, 07724, US

(21) Appl. No.: 10/813,925

(22) Filed: Mar. 31, 2004

(51) Int. Cl. G06F 17/60

(52) U.S. Cl. 705/14

(57) ABSTRACT

Ad information, such as ad targeting keywords and/or ad creative content for example, may be determined using aggregated selected document-to-query information associations. For example, popular terms and/or phrases also associated with a selected document may be used as ad targeting keywords and/or ad creative content for an ad having the document as a landing page. Query information may be tracked on a per document level, a per domain level, etc. The determined ad information may be used to automatically populate an ad record, or may be provided to an advertiser as suggested or recommended ad information.

### § 1. BACKGROUND OF THE INVENTION

§ 1.1 Field of the Invention

The present invention concerns advertising. In particular, the present invention concerns the targeted serving of ads.

§ 1.2 Background Information

Advertising using traditional media, such as television, radio, newspapers and magazines, is well known. Recently, advertising over more interactive media has become popular. For example, as the number of people using the Internet has exploded, advertisers have come to appreciate media and services offered over the Internet as a potentially powerful way to advertise.

Website-based ads (also referred to as “Web ads”) are often presented to their advertising audience in the form of “banner ads” (i.e., a rectangular box that includes graphic components). When a member of the advertising audience (referred to as a “viewer” or “user” in the Specification without loss of generality) selects one of these banner ads by clicking on it, embedded hypertext links typically direct the viewer to the advertiser's Website. The particular page to which the viewer is directed may be referred to as the “landing page” of the ad. Although the ad landing page may be a home page (e.g., a root of a Website), this is not necessary; it may be any page of a Website. The process where the viewer selects an ad is commonly referred to as a “clickthrough” (“Clickthrough” is intended to cover any user selection.).

Some search engines, such as Google for example, have enabled advertisers to target their ads so that they will be rendered with a search results page and so that they will be relevant, presumably, to the search query that prompted the search results page. Although search result pages afford advertisers a great opportunity to target their ads to a more receptive audience, they typically require advertisers to enter targeting information, such as keyword targeting information. For example, an ad may be considered relevant to a search results page and therefore eligible to be served with the search results page, if one or more of its targeting keywords match one or more terms from the search query. The Google ad system allows advertisers to target their ads in a one or more ways so that the ads will likely be relevant, and therefore useful, when served. For example, currently, advertisers may target ads using one of three keyword matching methods: exact; phrase; and broad. With exact matching, the query must be identical to keyword targeting criteria (i.e., one or more words or phrases used to make a targeting judgment (e.g., to determine whether an ad is relevant or not)). With phrase matching, the query must contain the targeting criteria words in the order specified by the phrase. Finally, with broad matching, the query must contain any one of one or more of the targeting criteria keywords, in any order. The advertiser may also define negative keywords such that if a search query includes a negative keyword, the ad will not be served.

From the perspective of the advertiser, the targeting keywords should generate a sufficient number of impressions, and should perform well (e.g., in terms of some metric such as clickthrough rate, conversion rate, etc.). If targeting keywords are subject to a competitive process, as is the case where advertisers make an offer (e.g., a bid, a maximum cost offer, etc.) for a keyword, many advertisers would appreciate finding targeting keywords that get impressions, perform well, but aren't so popular with other advertisers.

Some advertisers may find entering and/or maintaining keyword targeting information difficult, or at least tedious. Moreover, some advertisers may have trouble selecting the right keywords to obtain enough impressions and/or good performance for their ads. Thus, it would be useful to help advertisers by providing them with targeting information, such as targeting keywords for example.

The creative associated with an ad may also affect the performance of the ad. Some advertisers may find generating good ad creatives difficult. Thus, it would be useful to help advertisers by providing them with ad creative information, such as terms for inclusion in the content of the creative for example.

### § 2. SUMMARY OF THE INVENTION

The present invention may be used to determine ad targeting keywords for an advertiser. The present invention may do so by storing selected document information to query information associations, aggregating such associations, and, for an ad associated with a selected document, providing popular terms and/or phrases (hereafter referred to as “terms/phrases”) also associated with the selected document as ad targeting keywords for the ad.

The present invention may be used to determine ad creative content for an advertiser. The present invention may do so by storing selected document information to query information associations, aggregating such associations, and, for an ad associated with a selected document, including at least one popular term/phrase also associated with the selected document in the content of a creative for the ad.

In at least one embodiment of the present invention, the ad may use the selected document as its landing page. In at least one embodiment of the present invention, the document may be a Web page and may be identified by a URL. In at least one embodiment of the present invention, the document may be a Website homepage.

### § 3. BRIEF DESCRIPTION OF THE DRAWINGS

FIG. 1 is a high-level diagram showing parties or entities that can interact with an advertising system.

FIG. 2 is a bubble chart of an exemplary advertising environment in which, or with which, the present invention may operate.

FIG. 3 illustrates an exemplary search engine with which at least some aspects of the present invention may be used.

FIG. 4 is a bubble chart illustrating operations that may be used with search operations to associate query terms with selected documents in a manner consistent with the present invention.

FIG. 5 is a flow diagram of an exemplary method that may be used to associate query terms with selected documents and to aggregate such associations in a manner consistent with the present invention.

FIGS. 6A and 6B illustrate exemplary data structures that may be used to store selected document identifier to query term/phrase) associations in a manner consistent with the present invention.

FIG. 7 is a bubble chart illustrating operations that may use selected document information to query term associations to suggest targeting keywords for an ad, or a set of ads in a manner consistent with the present invention.

FIG. 8 is a flow diagram of an exemplary method that may be used to associate query terms with advertisements, and to use such query terms as one or more types of ad information, in a manner consistent with the present invention.

FIG. 9 is a flow diagram of an exemplary method that may be used, at one or more places, to reduce the amount of data being stored in a manner consistent with the present invention.

FIG. 10 is a block diagram of apparatus that may be used to perform at least some of the various operations that may be used and to store at least some of the information that may be used and/or generated in a manner consistent with the present invention.

FIGS. 11A-11D illustrate various exemplary operations of an exemplary embodiment of the present invention.

### § 4. DETAILED DESCRIPTION

The present invention may involve novel methods, apparatus, message formats and/or data structures for generating query information to selected document information association information and using such information to help advertisers. The following description is presented to enable one skilled in the art to make and use the invention, and is provided in the context of particular applications and their requirements. Thus, the following description of embodiments consistent with the present invention provides illustration and description, but is not intended to be exhaustive or to limit the invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

In the following, environments in which, or with which, the present invention may operate are described in § 4.1. Then, exemplary embodiments of the present invention are described in § 4.2. Examples of operations are provided in § 4.3. Finally, some conclusions regarding the present invention are set forth in § 4.4.

### § 4.1 Environments in which, or with which, the Present Invention may Operate

### § 4.1.1 Exemplary Advertising Environment

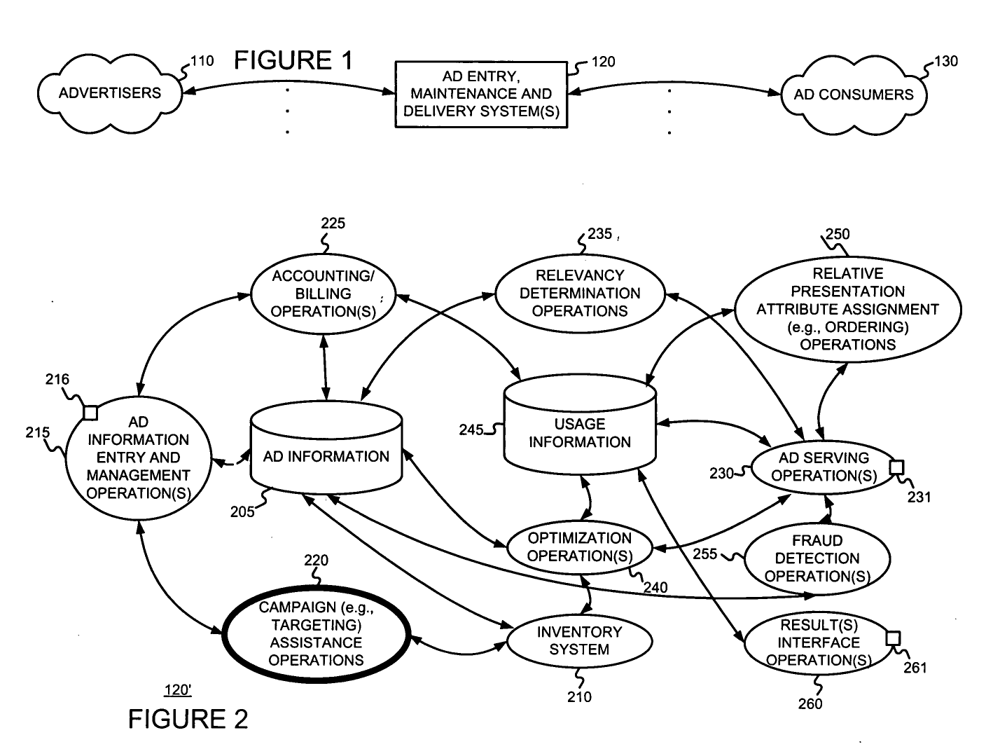

FIG. 1 is a high level diagram of an advertising environment in which, or with which, the present invention may operate. The environment may include an ad entry, maintenance and delivery system 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. Although not shown, other entities may provide usage information (e.g., whether or not a conversion or click-through related to the ad occurred) to the system 120. This usage information may include measured or observed user behavior related to ads that have been served.

One example of an ad consumer 130 is a general content server that receives requests for content (e.g., articles, discussion threads, music, video, graphics, search results, web page listings, etc.), and retrieves the requested content in response to, or otherwise services, the request. The content server may submit a request for ads to the system 120. Such an ad request may include a number of ads desired. The ad request may also include content request information. This information may include the content itself (e.g., page), a category corresponding to the content or the content request (e.g., arts, business, computers, arts-movies, arts-music, etc.), part or all of the content request, content age, content type (e.g., text, graphics, video, audio, mixed media, etc.), geolocation information, user local time information, etc.

The content server may combine the requested content with one or more of the advertisements provided by the system 120. This combined information including the content and advertisement(s) is then forwarded towards the end user that requested the content, for presentation to the viewer. Finally, the content server may transmit information about the ads and how, when, and/or where the ads are to be rendered (e.g., position, selection or not, impression time, impression date, size, conversion or not, etc.) back to the system 120. Alternatively, or in addition, such information may be provided back to the system 120 by some other means.

Another example of an ad consumer 130 is a search engine. A search engine may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine may submit a request for ads to the system 120. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate, a user local time, etc.), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., WebPages), full text of identified documents, feature vectors of identified documents, etc.

The search engine may combine the search results with one or more of the advertisements provided by the system 120. This combined information including the search results and advertisement(s) is then forwarded towards the user that requested the content, for presentation to the user. Preferably, the search results are maintained as distinct from the ads, so as not to confuse the user between paid advertisements and presumably neutral search results.

Finally, the search engine may transmit information about the ad and when, where, and/or how the ad was to be rendered (e.g., position, selection or not, impression time, impression date, size, conversion or not, etc.) back to the system 120. Alternatively, or in addition, such information may be provided back to the system 120 by some other means.

### § 4.1.2 Exemplary Ad Entry, Maintenance and Delivery Environment

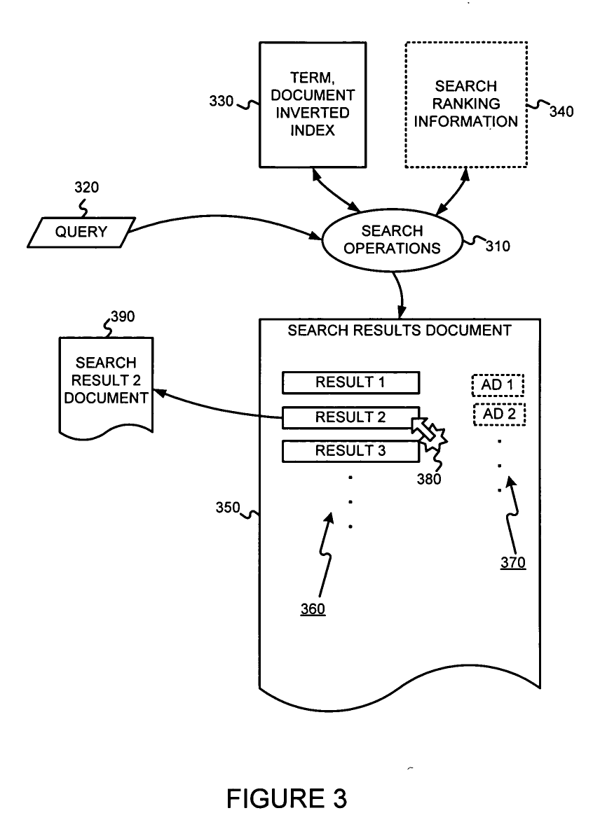

FIG. 2 illustrates an exemplary ad system 120′, consistent with the present invention. The exemplary ad system 120′ may include an inventory system 210 and may store ad information 205 and usage information 245. The exemplary system 120′ may support ad information entry and management operations 215, campaign (e.g., targeting) assistance operations 220, accounting and billing operations 225, ad serving operations 230, relevancy determination operations 235, optimization operations 240, relative presentation attribute assignment (e.g., position ordering) operations 250, fraud detection operations 255, and result interface operations 260.

Advertisers 110 may interface with the system 120′ via the ad information entry and management operations 215 as indicated by interface 216. Ad consumers 130 may interface with the system 120′ via the ad serving operations 230 as indicated by interface 231. Ad consumers 130 and/or other entities (not shown) may also interface with the system 120′ via results interface operations 260 as indicated by interface 261.

An advertising program may include information concerning accounts, campaigns, creatives, targeting, etc. The term “account” relates to information for a given advertiser (e.g., a unique email address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include a set of keywords, and a maximum price offer (cost per click-though, cost per conversion, etc.). Alternatively, or in addition, each ad group may include an average price offer (e.g., average cost per selection, average cost per conversion, etc.). Therefore, a single maximum price offer and/or a single average price offer may be associated with one or more keywords. As stated, each ad group may have one or more ads or “creatives” (That is, ad content that is ultimately rendered to an end user.). Naturally, the ad information 205 may include more or less information, and may be organized in a number of different ways.

The ad information 205 can be entered and managed via the ad information entry and management operations 215. Campaign (e.g., targeting) assistance operations 220 can be employed to help advertisers 110 generate effective ad campaigns. For example, the campaign assistance operations 220 can use information provided by the inventory system 210, which, in the context of advertising for use with a search engine, may track all possible ad impressions, ad impressions already reserved, and ad impressions available for given keywords. The ad serving operations 230 may service requests for ads from ad consumers 130. The ad serving operations 230 may use relevancy determination operations 235 to determine candidate ads for a given request. The ad serving operations 230 may then use optimization operations 240 to select a final set of one or more of the candidate ads. Finally, the ad serving operations 230 may use relative presentation attribute assignment operations 250 to order the presentation of the ads to be returned. The fraud detection operations 255 can be used to reduce fraudulent use of the advertising system (e.g., by advertisers), such as through the use of stolen credit cards. Finally, the results interface operations 260 may be used to accept result information (from the ad consumers 130 or some other entity) about an ad actually served, such as whether or not click-through occurred, whether or not conversion occurred (e.g., whether the sale of an advertised item or service was initiated or consummated within a predetermined time from the rendering of the ad), etc. Such results information may be accepted at interface 261 and may include information to identify the ad and time the ad was served, as well as the associated result.

When employed in a system such as that 120′ of FIG. 2, the present invention may be provided as one of the campaign assistance operations 220.

### § 4.1.3 Definitions

Online ads, such as those used in the exemplary systems described above with reference to FIGS. 1 and 2, or any other system, may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a page on which the ad was served, a search query or search results associated with the serving of the ad, a user characteristic (e.g., their geographic location, the language used by the user, the type of browser used, previous page views, previous behavior), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases, though, as alluded to above, the present invention obviates the need for an advertiser to enter targeting keywords. As yet another example, in some systems, an advertiser may specify that its ad is to be served only if a document being served includes certain topics or concepts, or falls under a particular cluster or clusters, or some other classification or classifications.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., click-throughs) of an ad to the number of impressions of the ad (i.e., the number of times an ad is displayed) is defined as the “selection rate” (or “click-through rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's web page, and consummates a purchase there before leaving that web page. Alternatively, a conversion may be defined as a user being shown an ad, and making a purchase on the advertiser's web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is displayed) is referred to as the “conversion rate.” If a conversion is defined to be able to occur within a predetermined time since the serving of an ad, one possible definition of the conversion rate might only consider ads that have been served more than the predetermined time in the past.

A “document” is to be broadly interpreted to include any machine-readable and machine-storable work product. A document may be a file, a combination of files, one or more files with embedded links to other files, etc.; the files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as Javascript, etc.). In many cases, a document has a unique, addressable, storage location and can therefore be uniquely identified by this addressable location. A universal resource locator (URL) is a unique address used to access information on the Internet.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer or Netscape), a media player (e.g., an MP3 player, a Realnetworks streaming audio file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

### § 4.1.4 Exemplary Search Engine

The present invention may use associations of query information and selected document information to determine terms/phrases. The determined terms/phrases may be used as targeting keywords for example. As another example, the content of an ad creative may use the determined terms/phrases. If such query information to selected document information associations are not provided, they may be determined. For example, they may be determined using a search engine.

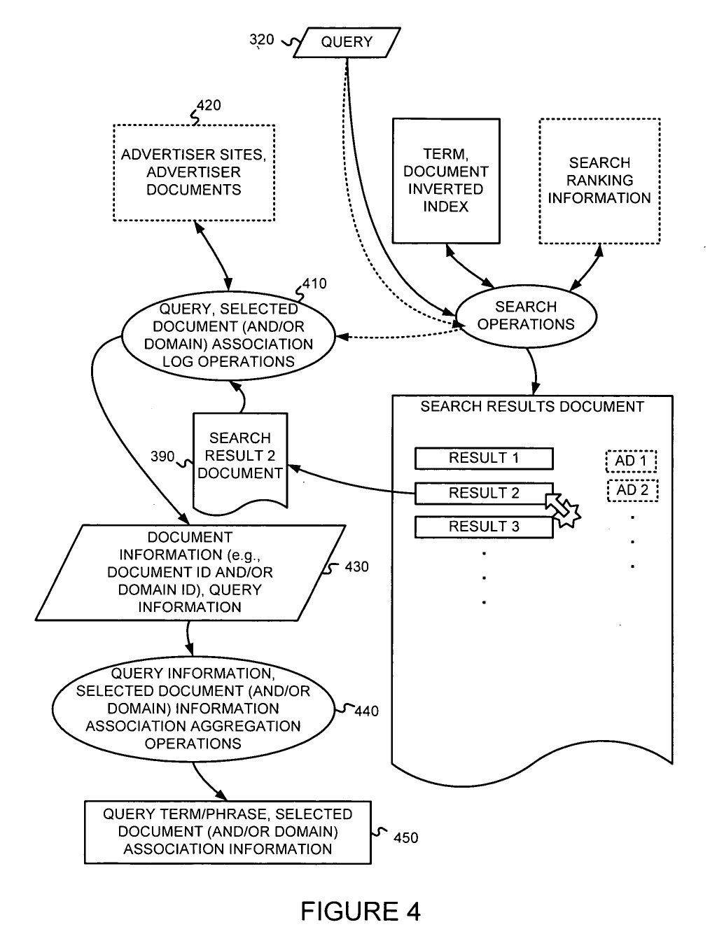

FIG. 3 illustrates an exemplary search engine with which at least some aspects of the present invention may be used. Search operations 310 accept query 320 and determine search results using, for example, a term-to-document inverted index 330 and possibly search ranking information. (See, e.g., U.S. Pat. No. 6,285,999.) The search results may be provided in a search results document 350, such as a Web page for example. The search results document may include a list of one or more search results 360. Note that if the search engine is also an ad consumer (which is not necessary to practice some aspects of the present invention), the search results document 350 may include one or more ads 370. A search result may include information indicative of the document determined to be relevant to the query 320, as well as a link (e.g., a hyper-text link) to that document. Information indicative of the document may include a document title, excerpts from the document (e.g., text excerpts or snippets of text proximal to terms used in the query 320), a location of the document, etc.

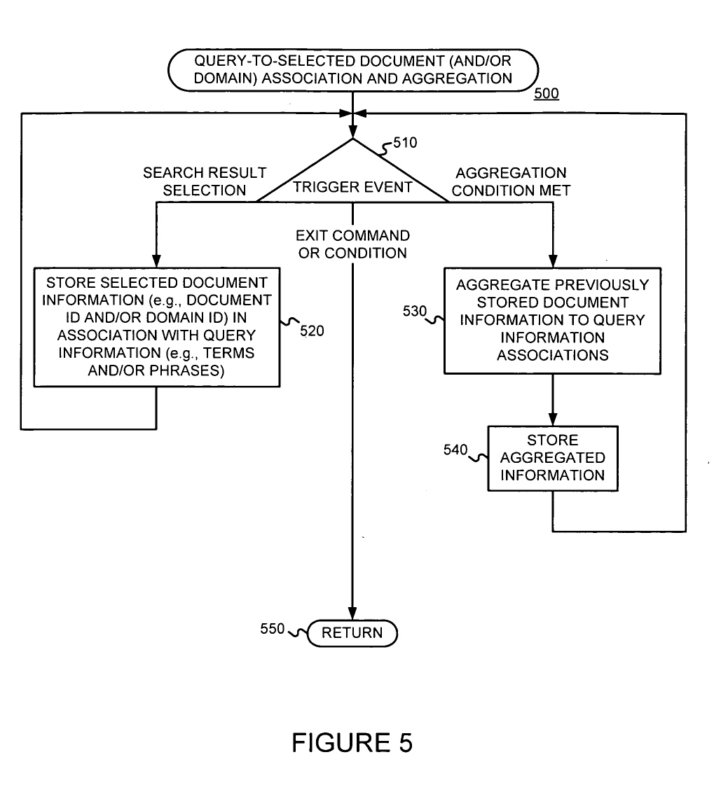

A user may select one of the search results 360, often by “clicking” the result. In this example, a user has selected result 2 as indicated by click 380. Such a selection brings the document 390 corresponding to search result 2 to the user (e.g., to a browser). The document 390 may be a Web page for example. Web pages may have a globally unique identifier, such as a universal resource locator (URL) for example. The Web page may be a home page (e.g., a root in a hierarchical Website or domain), or it may be a page of a Website other than a home page. Aspects of the present invention that may be used with such search operations are described with reference to FIG. 4 in § 4.2.1 below.

Various exemplary embodiments of the present invention are now described in § 4.2.

### § 4.2 Exemplary Embodiments

The present invention may be used to associate query terms with selected documents. This aspect of the present invention is described in § 4.2.1 below. The present invention may use such query term to selected document associations to populate ad information, such as targeting keywords, creative content, etc. This aspect of the present invention is described in § 4.2.2 below.

### § 4.2.1 Associating Query Terms with Selected Documents

FIG. 4 is a bubble chart illustrating operations that may be used with search operations, such as those described above with reference to FIG. 3, to associate query terms with selected documents. Elements already described above with reference to FIG. 3 are not described again.

Operations 410 to associate information from the query 320 with the selected document/domain (hereafter referred to simply as “document/domain”) 390 may be used to associate and store a document (and/or a domain) information (e.g., a document/domain identifier) and query information 430. If the selected document is a Web page, the document identifier may be its URL, and the domain identifier may be the home page of the Website to which the Web page belongs. The query information may simply be the query itself. Alternatively, the query information may be terms parsed from the query. Certain “stop” terms that often occur in search queries but which carry little or no meaning (e.g., “the,” “a,” “and,” “or,” “what,” “where,” etc.) may be filtered out of the query information. Information about existing advertiser documents/domains (e.g., a landing page specified by an ad of an advertiser, a home page of a Website of an advertiser, etc.) 420 may be used to filter out documents/domains selected that do not correspond to any existing advertiser. Such filtering, however, is not necessary.

Further operations 440 may be used to aggregate the document/domain information to query information associations 430, and store such aggregated information as query term/phrase to selected document/domain association information 450.

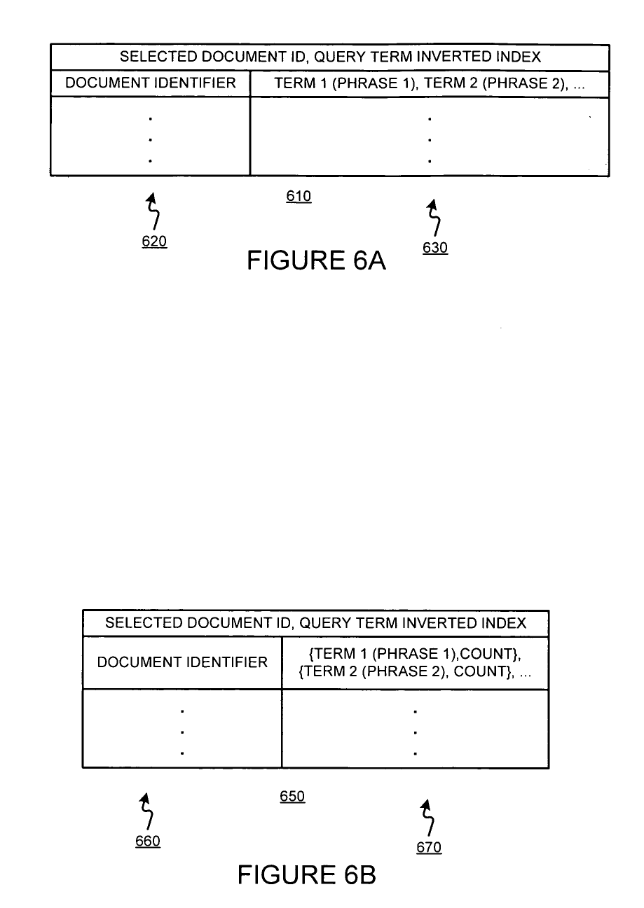

FIG. 5 is a flow diagram of an exemplary method 500 that may be used to associate query terms/phrases with selected documents/domains and to aggregate such associations. As indicated by block 510, various branches of the method 500 may be performed in response to various events. For example, if a search result is selected, information (e.g., an identifier) of a document/domain associated with the search result is associated with query information, such as terms/phrases of the query for example, and the association is stored. (Block 520) Referring back to block 510, if an aggregation condition (e.g., the expiration of a time period, a command for aggregation, the acquisition of a certain amount of data, etc.) is met, previously stored document/domain information to query information associations are aggregated (Block 530) and the aggregated information is stored (Block 540). The method 500 may be left upon the occurrence of an exit command or condition. (Node 550)

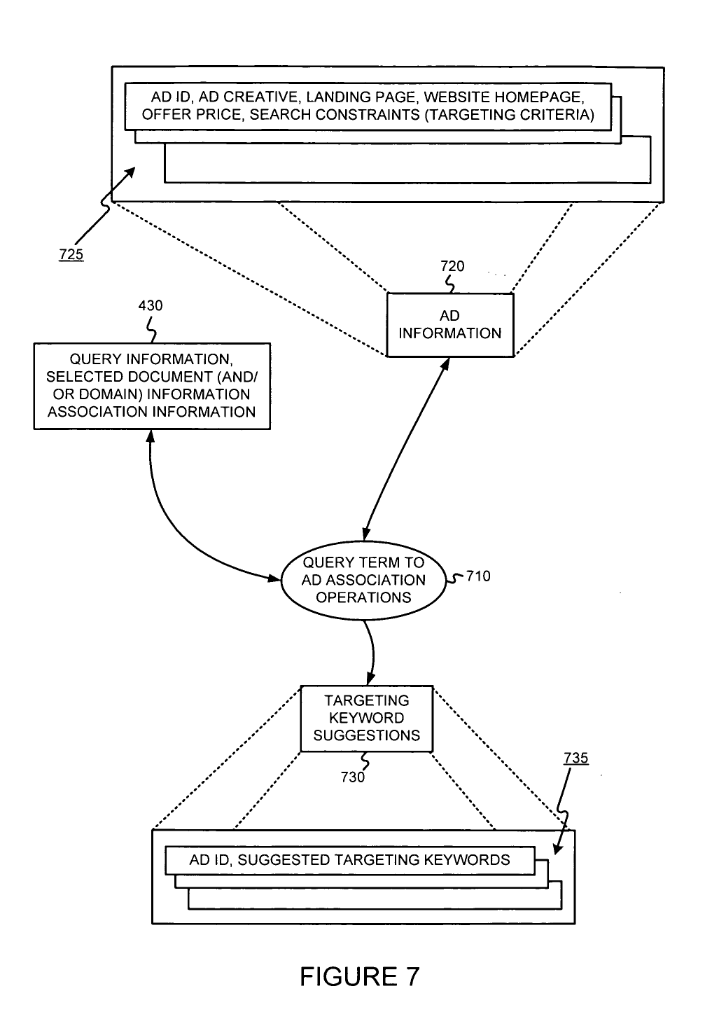

FIGS. 6A and 6B illustrate exemplary data structures that may be used to store aggregated selected document/domain information to query term/phrase associations. FIG. 6A illustrates an index 610 in which a document/domain identifier 620 may be used as a primary key to look up one or more associated terms/phrases 630. The entries of the index 610 may be ordered using the document/domain identifiers 620.

FIG. 6B illustrates an alternative index 650 in which a document/domain identifier 660 may be used as a primary key to look up one or more associated {term, term count} and/or {phrase, phrase count} pairs 670. The pairs 670 may be ordered based on the counts. In this way, terms/phrases that have been used more frequently in queries that generated a search result, the selection of which led to the document, can be ordered ahead of those used less frequently. The entries of the index 650 may be ordered using the document/domain identifiers 660.

### § 4.2.2 Using Query Term to Selected Document Associations

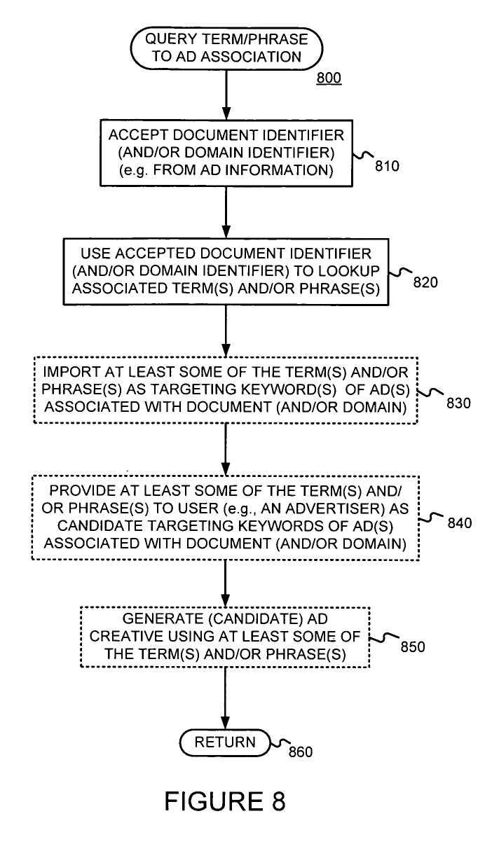

FIG. 7 is a bubble chart illustrating operations that may use selected document to query term associations to suggest targeting keywords for an ad, or a set of ads. Query term/phrase to ad association operations 710 may use query term/phrase to selected document/domain association information 450 and ad information 720 to generate targeting keyword suggestions 730 for one or more ads. In an exemplary embodiment of the present invention, the ad information 720 may include one or more of an ad identifier, an ad creative, a landing page (e.g., a document identifier, such as a Web page URL), a Website home page (domain), an offer price (e.g., a bid or maximum cost offer (e.g., per impression, selection, conversion, etc.) for one or more targeting criteria, such as one or more targeting keywords, etc.), and search constraints (e.g., targeting keywords, geotargeting information, time/date targeting information, etc.) 725. In an exemplary embodiment of the present invention, the targeting keyword suggestions 730 may include one or more elements, each including an ad identifier and one or more suggested targeting keywords 735.

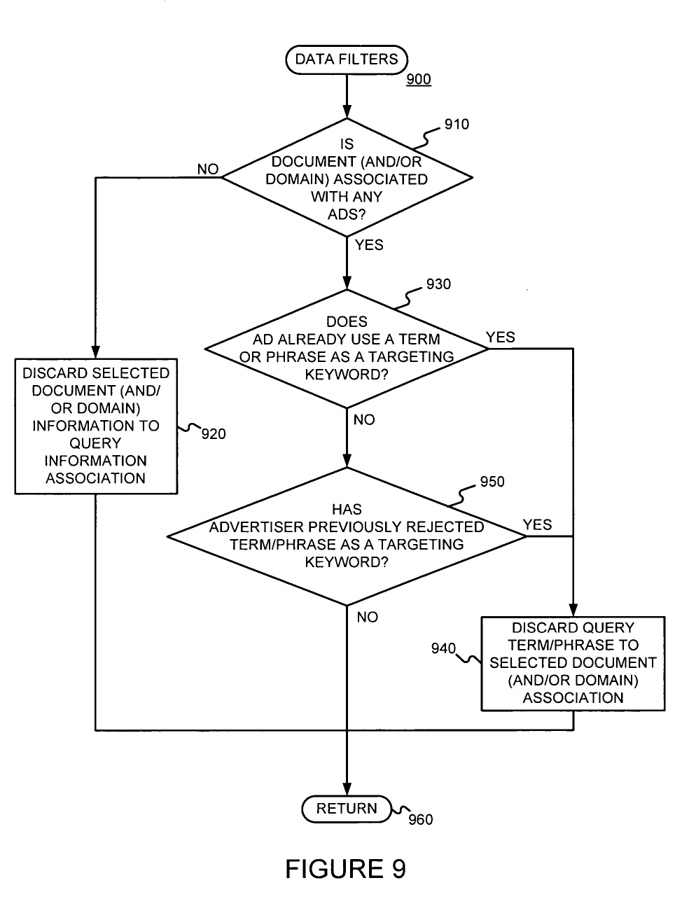

FIG. 8 is a flow diagram of an exemplary method 800 that may be used to associate query terms/phrases with advertisements, and use such query terms/phrases as one or more types of ad information. Document/domain identifier information is accepted. (Block 810) For example, such information may be accepted from ad information. More specifically, an advertiser may have specified a landing page URL and/or a Website URL for an ad. The accepted document/domain identifier may then be used to lookup associated terms/phrase. (Block 820) Recall, for example, exemplary data structures 610 and 650 of FIGS. 6A and 6B, respectively, in which a document/domain identifier 620/660 can be used as a lookup key to find associated terms/phrases 630,670.

Having found associated terms/phrases, one or more of acts 830, 840 and 850 may be performed, depending on the desired application. For example, at least some of the terms/phrases may be imported as targeting keyword(s) for ad(s) associated with the document/domain. (Block 830) At least some of the terms/phrases may be provided to a user (e.g., an advertiser) as candidate targeting keywords for an ad(s) associated with the identified document/domain. (Block 840) At least some of the terms/phrases may be used to generate an (e.g., a candidate) ad creative. (Block 850) For example, the terms/phrases may be used to populate certain parts of a generic creative template.

### § 4.2.3 Refinements and Alternatives

Recall from FIG. 6B that counts may be associated with terms/phrases, which are associated with a document identifier. These counts may be used in conjunction with absolute and/or relative thresholds or tests in certain applications. For example, if the terms/phrases are to be provided as targeting keywords, they may have to have a certain minimum count to be considered. As another example, only the N terms/phrases with the highest counts might be considered. As yet another example, if the terms/phrases are to be provided as elements of an ad creative, only the term or phrase with the highest count might be used.

Such thresholding permits a number of useful features. For example, it may be desirable to ensure that a term or phrase will likely generate a number of impressions deemed sufficient. Alternatively, or in addition, thresholding can be applied to queries. For example, if a query occurred only one time (or only a very few times), or was issued by only one user, it may be discarded to preserve user privacy.

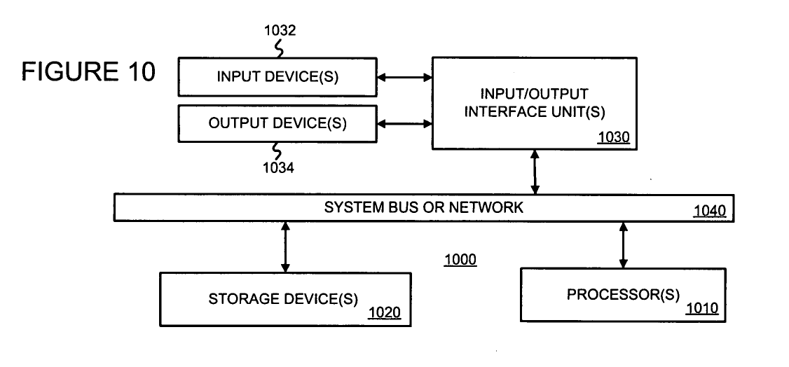

FIG. 9 is a flow diagram of an exemplary method 900 that may be used, at one or more places, to reduce the amount of data being stored. At decision block 910, it is determined whether or not a document/domain is associated with an ad or ads. If not, the document/domain information to query information association may be discarded. (Block 920) For example, referring back to FIG. 4, associated document information and query information 430 that has no associated ad may be discarded, or not generated in the first place. Referring back to FIG. 9, at decision block 930, it is determined whether or not an ad already uses a term or phrase as a targeting keyword. If so, the query term or phrase may be discarded. (Block 940) This can be used to avoid the need to save a suggested targeting keyword for an ad that is already being used by the ad. At decision block 950, it is determined whether or not an advertiser has previously rejected a term or phrase as a targeting keyword. If so, the query term or phrase may be discarded. (Block 940) This can be used to avoid the need to save a suggested targeting keyword that has already been considered and declined by an advertiser. Various other data filtering acts are possible and will often depend on the application(s) for which the data will ultimately be used.

As discussed above, terms/phrases can be associated with a selected document/domain. One application is to track keywords by document and to automatically generate a creative relevant to the document to association with such keywords. For example, many Websites may have Web pages with unique, non-overlapping content, and linking an ad to a landing page with content a user is interested in, rather than just the advertiser's home page, will presumably be more useful to the user. For example, a large Website may have different Web pages for different products and/or services. As another example, a large Website might have different Web pages for different languages.

The granularity with which query information is associated with document information may be application specific. For example, associating query information with domain information might make sense for smaller Websites with few pages, often with related information, such as a local dry cleaner for example. On the other hand associating query information with individual Web pages might make sense for larger Websites (such as Amazon.com, or Walmart.com for example) offering a large number of different products and services. Some Websites offer a large number of diverse products, such as books, consumer electronics, and power tools. In one exemplary embodiment, a document (e.g., Web page) count threshold of a Website might be used to determine the level of granularity to use (e.g., per domain, per document, etc.) for a given domain (e.g., Website). Alternatively, or in addition, concept clustering may be used to determine the level of granularity to use. For example, the number of distinct concepts a Website covers, and perhaps how far apart those concepts are may be considered. In such an embodiment, for Websites having Web pages that concern a number of very different concepts, the query information may be associated with the document information with a finer level of granularity. On the other hand, for Websites having Web pages that only concern one topic or just a few very closely related topics, the query information may be associated with the document information with a more coarse level of granularity. In at least some embodiments consistent with the present invention, whether or not Web pages of a Website concern closely related concepts might be inferred from the link structure topology (e.g., a straight tree, a mesh, etc.) of the Website. Alternatively, or in addition, the level of granularity used may be a function of the specificity of the query and how a concept of the query matches the concepts of Web pages of the Website (e.g., Web pages to “appliances”, “kitchen appliances”, “toaster ovens” and Black & Decker Model 500 Toaster Oven”).

### § 4.2.4 Exemplary Apparatus

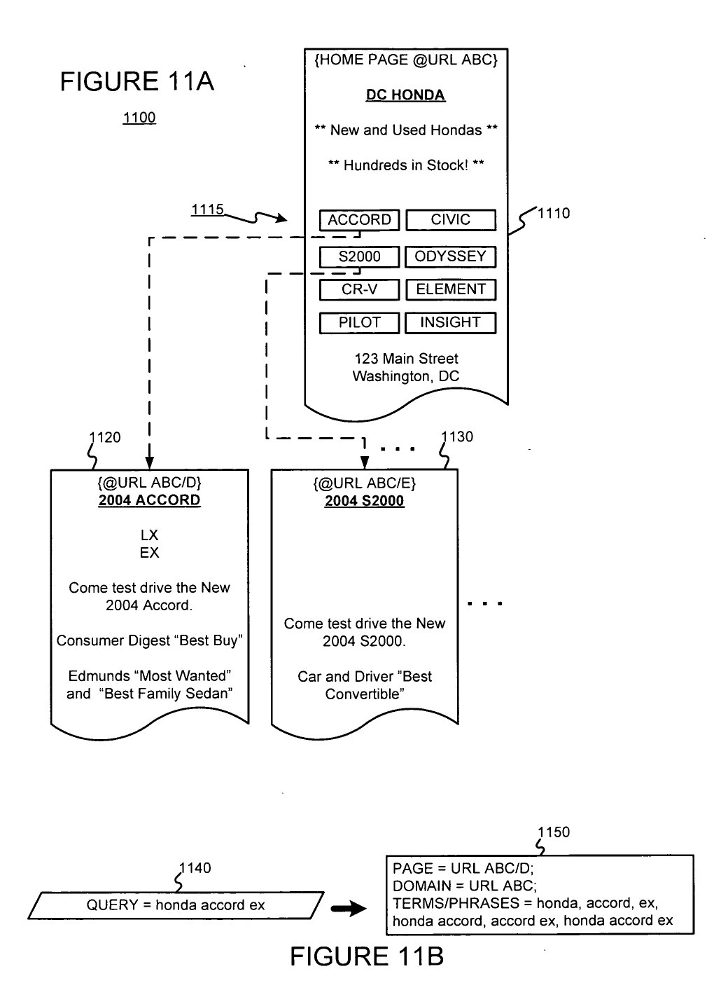

FIG. 10 is high-level block diagram of a machine 1000 that may perform one or more of the operations discussed above. The machine 1000 may include one or more processors 1010, one or more input/output interface units 1030, one or more storage devices 1020, and one or more system buses and/or networks 1040 for facilitating the communication of information among the coupled elements. One or more input devices 1032 and one or more output devices 1034 may be coupled with the one or more input/output interfaces 1030.

The one or more processors 1010 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. At least a portion of the machine executable instructions may be stored (temporarily or more permanently) on the one or more storage devices 1020 and/or may be received from an external source via one or more input interface units 1030.

In one embodiment, the machine 1000 may be one or more conventional personal computers. In this case, the processing units 1010 may be one or more microprocessors. The bus 1040 may include a system bus. The storage devices 1020 may include system memory, such as read only memory (ROM) and/or random access memory (RAM). The storage devices 1020 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 1032, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 1010 through an appropriate interface 1030 coupled to the system bus 1040. The output devices 1034 may include a monitor or other type of display device, which may also be connected to the system bus 1040 via an appropriate interface. In addition to (or instead of) the monitor, the personal computer may include other (peripheral) output devices (not shown), such as speakers and printers for example.

The various operations described above may be performed by one or more machines 1000, and the various information described above may be stored on one or more machines 1000.

### § 4.3 Examples of Operations

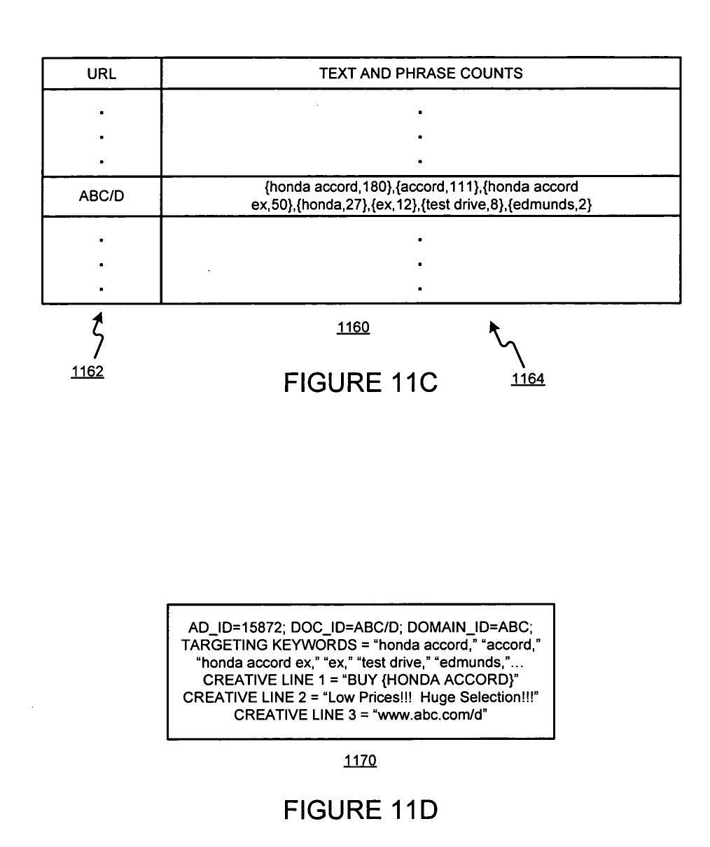

FIGS. 11A-11D provide an example which illustrates various operations of an exemplary embodiment of the present invention. FIG. 11A illustrates a Website 1100, including a home page 1110 with a unique identifier (e.g., URL) ABC. The home page 1110 includes a number of links 1115 to other Web pages 1120, 1130, etc. Web pages 1120 and 1130 have unique identifiers ABC/D and ABC/E, respectively. In this example, documents include Web pages 1110, 1120, 1130, etc., document identifiers include URLs ABC, ABC/D, ABC/E, etc., the domain may be the home page 1110, and the domain identifier may be URL ABC.

FIG. 11B illustrates a search query 1140 and selected document/domain to query term/phrase associations 1150 that may be generated if Web page 1120 is selected from a search result list generated by the search query 1140. More specifically, suppose that query 1140 is “honda accord ex” and that after being presented with one or more search results, the user that submitted the query selects Web page 1120. The information 1150 may include an identifier of Web page 1120, such as the URL ABC/D for example, an identifier of a domain 1110 to which the Web page 1120 belongs, such as URL ABC for example, and one or mores or phrases from the search query 1140, such as “honda,” “accord,” “ex,” “honda accord,” “accord ex,” and “honda accord ex.” Note that in many cases, the domain identifier may be a truncation of the document identifier. For example, the URL ABC is a truncation of the URL ABC/D. Thus, if a domain identifier might be derivable from a document identifier. If so, it might not be desirable to store both in some embodiments.

FIG. 11B illustrates information 1150 generated pursuant to one selection. Recall that information is aggregated over a plurality of such selections. Recall further, from FIG. 6B, that such aggregated information may be stored in a data structure indexed by a document identifier and including {term/phrase,count} pairs. FIG. 11C illustrates aggregated information indexed by Web page URLS 1162 and including {term/phrase,count} pairs 1164. As shown, an entry for Web page 1120 is indexed by the URL ABC/D and includes the pairs {honda accord,180}, {accord,111}, {honda accord ex,50}, {Honda,27}, {ex,12}, {test drive,8} and {edmunds,2}. Note that although a phrase may occur in fewer queries, they may nonetheless be associated with more selections for a given document or Web page.

Finally, recall that such aggregated information may be used to suggest or populate ad targeting keywords, suggest or populate at least a part of ad creatives, etc. FIG. 11D illustrates ad information 1170, at least some of which may have been populated by aggregated selected document to query term/phrase associations. The landing page of the ad may be defined by document identifier (DOC_ID) ABC/D. As can be appreciated from FIGS. 11C and 11D, the ad targeting keywords, “honda accord,” “accord,” “honda accord ex,” honda,” “ex,” “test drive” and “edmunds” for the ad may have been determined from the aggregated text and phrase information.

In this example, the ad is a text ad and the ad information 1170 includes a three line ad creative. In this example, the first line of the ad creative may have been generated by a template “BUY {most popular term/phrase},” which, in this case, is “honda accord.” Thus, the generated first line of the creative is “BUY HONDA ACCORD.”

As can be appreciated from the foregoing example, an advertiser need only provide a landing page and targeting keywords and/or creative content may be generated automatically, or at least provided as suggestions for the advertiser's approval. Similarly, the advertiser could merely provide a domain or Website home page, and different ads corresponding to different Web pages of the domain may be generated.

### § 4.4 CONCLUSIONS

As can be appreciated from the foregoing disclosure, the present invention can be used to help advertisers easily generate effective targeted ad information such as ad targeting keywords and/or ad creative content. Further, the present invention can be used to help an advertiser having a Website with different Web pages selling different products or services to generate a number of different ads, each optimized to one of the different Web pages.

1. A method comprising:
a) accepting a document identifier;
b) using the accepted document identifier to obtain at least one of (A) one or more terms and (B) one or more phrases; and
c) providing the obtained at least one of (A) one or more terms and (B) one or more phrases as ad information for an ad, wherein the ad has a landing page document, and wherein the landing page document corresponds to a document identified by the document identifier.

2. The method of claim 1 wherein the document is a Web page.

3. The method of claim 2 wherein the document identifier is a universal resource locator.

4. The method of claim 1 wherein the act of using the accepted document identifier to obtain at least one of (A) one or more terms and (B) one or more phrases uses information which stores aggregated associations of search query information to selected documents.

5. The method of claim 1 wherein the act of providing the obtained at least one of (A) one or more terms and (B) one or more phrases as ad information for an ad includes populating keyword targeting information of the ad.

6. The method of claim 1 wherein the act of providing the obtained at least one of (A) one or more terms and (B) one or more phrases as ad information for an ad includes suggesting keyword targeting information to an advertiser.

7. The method of claim 1 wherein the act of providing the obtained at least one of (A) one or more terms and (B) one or more phrases as ad information for an ad includes populating at least some content of a creative of the ad.

8. The method of claim 1 wherein the act of providing the obtained at least one of (A) one or more terms and (B) one or more phrases as ad information for an ad includes suggesting at least some content of a creative of the ad to an advertiser.

9. A method comprising:
a) accepting a domain identifier;
b) using the accepted domain identifier to obtain at least one of (A) one or more terms and (B) one or more phrases; and
c) providing the obtained at least one of (A) one or more terms and (B) one or more phrases as ad information for an ad, wherein the ad has a landing page document, and wherein the landing page document belongs to the domain identified by the domain identifier.

10. The method of claim 9 wherein the document is a Web page, and wherein the domain is a Website which includes the Web page.

11. The method of claim 10 wherein the domain identifier is a universal resource locator.

12. The method of claim 9 wherein the act of using the accepted domain identifier to obtain at least one of (A) one or more terms and (B) one or more phrases uses information which stores aggregated associations of search query information to domains including selected documents.

13. The method of claim 9 wherein the act of providing the obtained at least one of (A) one or more terms and (B) one or more phrases as ad information for an ad includes populating keyword targeting information of the ad.

14. The method of claim 9 wherein the act of providing the obtained at least one of (A) one or more terms and (B) one or more phrases as ad information for an ad includes suggesting keyword targeting information to an advertiser.

15. The method of claim 9 wherein the act of providing the obtained at least one of (A) one or more terms and (B) one or more phrases as ad information for an ad includes populating at least some content of a creative of the ad.

16. The method of claim 9 wherein the act of providing the obtained at least one of (A) one or more terms and (B) one or more phrases as ad information for an ad includes suggesting at least some content of a creative of the ad to an advertiser.

17. A method comprising:
a) storing, in response to a selection of a search result generated by a search query, and corresponding to a linked document, an association of information of the linked document and information of the search query;
b) aggregating stored associations of information of documents and information of search queries to generate aggregated document information to search query information associations; and
c) storing the aggregated document information to search query information associations.

18. The method of claim 17 wherein the information of the linked document is a document identifier.

19. The method of claim 18 wherein the document is a Web page.

20. The method of claim 18 wherein the document identifier is a universal resource locator.

21. The method of claim 17 wherein the information of the linked document is a domain identifier, and wherein the domain includes the linked document.

22. The method of claim 21 wherein the linked document is a Web page and wherein the domain is a Website.

23. The method of claim 17 wherein the query information includes at least one of (A) one or more terms and (B) one or more phrases.

24. The method of claim 17 wherein the query information includes at least one of (A) one or more pairs of term and term count and (B) one or more pairs of phrase and phrase count.

25. The method of claim 17 further comprising:
d) accepting a document identifier;
e) using the accepted document identifier to obtain at least one of (A) one or more terms and (B) one or more phrases from the stored aggregated document information to search query information associations; and
f) providing the obtained at least one of (A) one or more terms and (B) one or more phrases as ad information for an ad, wherein the ad has a landing page document, and wherein the landing page document corresponds to a document identified by the document identifier.

26. The method of claim 25 wherein the document is a Web page.

27. The method of claim 26 wherein the document identifier is a universal resource locator.

28. The method of claim 25 wherein the act of providing the obtained at least one of (A) one or more terms and (B) one or more phrases as ad information for an ad includes populating keyword targeting information of the ad.

29. The method of claim 25 wherein the act of providing the obtained at least one of (A) one or more terms and (B) one or more phrases as ad information for an ad includes suggesting keyword targeting information to an advertiser.

30. The method of claim 25 wherein the act of providing the obtained at least one of (A) one or more terms and (B) one or more phrases as ad information for an ad includes populating at least some content of a creative of the ad.

31. The method of claim 25 wherein the act of providing the obtained at least one of (A) one or more terms and (B) one or more phrases as ad information for an ad includes suggesting at least some content of a creative of the ad to an advertiser.

32. A computer-readable medium storing a data structure comprising:
a) a plurality of entries, each of the plurality of entries including
i) a first field for storing a document identifier, and
ii) a second field for storing at least one of (A) one or more terms and (B) one or more phrases,
wherein the document identifier stored in the first field corresponds to a document selected from a search result list generated by a search query, and at least one of (A) one or more terms and (B) one or more phrases stored in the second field was included in the search query.

33. The computer-readable medium of claim 32 wherein the document is a Web page.

34. The computer-readable medium of claim 33 wherein the document identifier is a universal resource locator.

35. The computer-readable medium of claim 32 wherein the document is a home page of a Website.

36. The computer-readable medium of claim 35 wherein the document identifier is a universal resource locator.

37. A computer-readable medium storing a data structure comprising:
a) a plurality of entries, each of the plurality of entries including
i) a first field for storing a document identifier, and
ii) a second field for storing at least one of (A) one or more pairs of term and term count and (B) one or more pairs of phrase and phrase count.
wherein the document identifier stored in the first field corresponds to a document selected from one or more search result lists generated by one or more search queries, wherein at least one of (A) one or more terms and (B) one or more phrases stored in the second field were included in at least one of the one or more search queries, and wherein the term count corresponds to the number of the one or more search queries that included the associated term, and the phrase count corresponds to the number of the one or more search queries that included the associated phrase.

38. The computer-readable medium of claim 37 wherein the document is a Web page.

39. The computer-readable medium of claim 38 wherein the document identifier is a universal resource locator.

40. The computer-readable medium of claim 37 wherein the document is a home page of a Website.

41. The computer-readable medium of claim 40 wherein the document identifier is a universal resource locator.

42. Apparatus comprising:
a) an input for accepting a document identifier;
b) means for obtaining at least one of (A) one or more terms and (B) one or more phrases, using the accepted document identifier; and
c) means for providing the obtained at least one of (A) one or more terms and (B) one or more phrases as ad information for an ad, wherein the ad has a landing page document, and wherein the landing page document corresponds to a document identified by the document identifier.

43. The apparatus of claim 42 wherein the document is a Web page.

44. The apparatus of claim 43 wherein the document identifier is a universal resource locator.

45. The apparatus of claim 42 wherein the means for obtaining at least one of (A) one or more terms and (B) one or more phrases, use information which stores aggregated associations of search query information to selected documents.

46. The apparatus of claim 42 wherein the means for providing the obtained at least one of (A) one or more terms and (B) one or more phrases as ad information for an ad include means for populating keyword targeting information of the ad.

47. The apparatus of claim 42 wherein the means for providing the obtained at least one of (A) one or more terms and (B) one or more phrases as ad information for an ad include means for suggesting keyword targeting information to an advertiser.

48. The apparatus of claim 42 wherein the means for providing the obtained at least one of (A) one or more terms and (B) one or more phrases as ad information for an ad include means for populating at least some content of a creative of the ad.

49. The apparatus of claim 42 wherein the means for providing the obtained at least one of (A) one or more terms and (B) one or more phrases as ad information for an ad include means for suggesting at least some content of a creative of the ad to an advertiser.

50. Apparatus comprising:
a) an input for accepting a domain identifier;
b) means for obtaining at least one of (A) one or more terms and (B) one or more phrases, using the accepted domain identifier; and
c) means for providing the obtained at least one of (A) one or more terms and (B) one or more phrases as ad information for an ad, wherein the ad has a landing page document, and wherein the landing page document belongs to the domain identified by the domain identifier.

51. The apparatus of claim 50 wherein the document is a Web page, and wherein the domain is a Website which includes the Web page.

52. The apparatus of claim 51 wherein the domain identifier is a universal resource locator.

53. The apparatus of claim 50 wherein the means for obtaining at least one of (A) one or more terms and (B) one or more phrases, use information which stores aggregated associations of search query information to domains including selected documents.

54. The apparatus of claim 50 wherein the means for providing the obtained at least one of (A) one or more terms and (B) one or more phrases as ad information for an ad include means for populating keyword targeting information of the ad.

55. The apparatus of claim 50 wherein the means for providing the obtained at least one of (A) one or more terms and (B) one or more phrases as ad information for an ad include means for suggesting keyword targeting information to an advertiser.

56. The apparatus of claim 50 wherein the means for providing the obtained at least one of (A) one or more terms and (B) one or more phrases as ad information for an ad include means for populating at least some content of a creative of the ad.

57. The apparatus of claim 50 wherein the means for providing the obtained at least one of (A) one or more terms and (B) one or more phrases as ad information for an ad include means for suggesting at least some content of a creative of the ad to an advertiser.

58. Apparatus comprising:
a) means for storing, in response to a selection of a search result generated by a search query, and corresponding to a linked document, an association of information of the linked document and information of the search query;
b) means for aggregating stored associations of information of documents and information of search queries to generate aggregated document information to search query information associations; and
c) means for storing the aggregated document information to search query information associations.

59. The apparatus of claim 58 wherein the information of the linked document is a document identifier.

60. The apparatus of claim 59 wherein the document is a Web page.

61. The apparatus of claim 59 wherein the document identifier is a universal resource locator.

62. The apparatus of claim 58 wherein the information of the linked document is a domain identifier, and wherein the domain includes the linked document.

63. The apparatus of claim 62 wherein the linked document is a Web page and wherein the domain is a Website.

64. The apparatus of claim 58 wherein the query information includes at least one of (A) one or more terms and (B) one or more phrases.

65. The apparatus of claim 58 wherein the query information includes at least one of (A) one or more pairs of term and term count and (B) one or more pairs of phrase and phrase count.

66. The apparatus of claim 58 further comprising:
d) an input for accepting a document identifier;
e) means for obtaining at least one of (A) one or more terms and (B) one or more phrases from the stored aggregated document information to search query information associations, using the accepted document identifier; and
f) means for providing the obtained at least one of (A) one or more terms and (B) one or more phrases as ad information for an ad, wherein the ad has a landing page document, and wherein the landing page document corresponds to a document identified by the document identifier.

67. The apparatus of claim 66 wherein the document is a Web page.

68. The apparatus of claim 67 wherein the document identifier is a universal resource locator.

69. The apparatus of claim 66 wherein the means for providing the obtained at least one of (A) one or more terms and (B) one or more phrases as ad information for an ad include means for populating keyword targeting information of the ad.

70. The apparatus of claim 66 wherein the means for providing the obtained at least one of (A) one or more terms and (B) one or more phrases as ad information for an ad include means for suggesting keyword targeting information to an advertiser.

71. The apparatus of claim 66 wherein the means for providing the obtained at least one of (A) one or more terms and (B) one or more phrases as ad information for an ad include means for populating at least some content of a creative of the ad.

72. The apparatus of claim 66 wherein the means for providing the obtained at least one of (A) one or more terms and (B) one or more phrases as ad information for an ad include means for suggesting at least some content of a creative of the ad to an advertiser.
